(19) United States
(12) Patent Application Publication
(10) Pub. No.: US 2010/0213699 A1
(43) Pub. Date: Aug. 26, 2010

(54) Thematic paper napkin set

(76) Inventor: Maureen Tremper, Mt. Olive, NJ (US)

Correspondence Address: THOMAS J. GERMINARIO, ESQ., 154 ROUTE 206, CHESTER, NJ, 07930, US

(21) Appl. No.: 12/379,458

(22) Filed: Feb. 23, 2009

(51) Int. Cl. B42D 15/00

(52) U.S. Cl. 283/117

(57) ABSTRACT

Various thematic sets of paper napkins are comprised of individual napkins, each of which is imprinted with different question or group of questions relating to a specific subject, theme, age group, interest and/or social setting. The questions are imprinted on an outer ply of the napkin, while answers and/or hints to the questions can be imprinted on the inner plies of the napkin.

### BACKGROUND OF THE INVENTION

The present invention relates to the field of thematic paper napkins containing printed indicia and/or images. More specifically, the present invention relates to sets of multiple paper napkins, each one of which bears different and distinct printed indicia and/or images, all of which refer to a specific theme, occasion, social setting and/or realm of knowledge.

The present invention relates to specially fabricated sets of paper napkins, each of which contain one of a series of distinct printed questions directed at a specific subject matter, theme, age group, interest and/or social setting. The consumer would be able to select from a range of different napkin sets designed for various occasions and contexts, such as family dinners, social gatherings and school functions. Some napkin sets would contain multiple instructional questions geared toward academic use at various grade levels. Others would contain questions posing hypothetical situations designed to serve as a starting point for conversation.

The use of thematic imprints on paper napkins is well known in the art. Such imprints typically relate to holidays, such as Thanksgiving or Christmas, or special occasions, such as a birthday or anniversary. They are sold in sets in which all of the napkins usually bear the same imprint. Also well known in the art are paper napkins that bear indicia and/or images having an advertising or promotional message. For example, cocktail napkins bearing imprints related to a particular brand of beverage are often used in bars and restaurants.

Printed advertising or informative material on a cocktail napkin is disclosed in Allen, U.S. Pat. No. 4,378,391. But the Allen patent does not deal with thematic sets of printed napkins in which each napkin bears a different question or group of questions.

The patent publication of Wong, Pub. No. US2004/0094278, deals with pre-printed paper napkins, but the purpose of the printing is to create the appearance of 3-dimensional object rather than to pose questions or convey information.

The patent publication of Errazuriz, Pub. No. US2006/0228526, relates to a disposable placemat made of embossed paper bearing publicity on its upper face. Here again, the key element of a series of thematically coordinated printed napkin questions is missing in the Errazuriz invention.

Therefore, the prior art neither teaches nor suggests the principal features of the present invention, which are:
Sets of multiple paper napkins, in which
Each individual napkins contains a different question or group of questions, and in which
All of the questions relate to a specific subject, theme, age group, interest and/or social setting.

### SUMMARY OF THE INVENTION

The present invention can be practiced in a number of embodiments, which should be understood before one specific embodiment is described in detail. For illustrative purposes, some of these embodiments will now be discussed for the purpose of conveying a better understanding of the general intent of the present invention. It should be understood, however, that neither the following illustrative embodiments, nor the detailed embodiment described in the next section of this application, are intended to limit the scope of the present invention.

A first illustrative embodiment is a set of paper napkins bearing a series of questions aimed at young children and presenting various hypothetical situations to which the child is asked to respond. In this embodiment, the purpose of the questions is to prompt conversation during a family gathering, such as a dinner, and to give parents an entertaining way to teach their children about health, safety, ethics and/or social norms. For this embodiment, some exemplary questions imprinted on the napkins could be:
What would you say to a stranger who offers you a piece of candy?
What would you do if your friend asked to copy your homework?
A stray dog follows you home: What do you do?

A second illustrative embodiment is a set of paper napkins bearing a series of questions intended to be “conversation starters” at adult social gatherings. In this embodiment, the questions would have no “right” or “wrong” answers, but would instead help to “break the ice” and get people talking to each other. Such questions would often be intended to elicit a humorous or whimsical response. Some exemplary questions that might appear on the individual napkins of this embodiment could be:
Who are better listeners, men or women?
Do you have a guardian angel?
When was the last time you got drunk?

A third illustrative embodiment is a set of paper napkins bearing a series of questions pertaining to a particular theme, such as the movies. In this embodiment, the napkin questions could be the basis of a competitive game, in which participants try to outperform others in their knowledge of the subject. Some potential napkin questions in the “movies category” for this embodiment could be:
Who directed the film “On the Waterfront”?
Name two actors from the film “Citizen Kane”.
What was the last silent film in which Charlie Chaplin appeared?

Since paper napkins are typically folded in four quadrants, some embodiments of the present invention can have napkins that contain printed questions on each of the napkin panels. Alternately, a question can be printed on the front panel of the napkin and the answer can be viewed by unfolding the napkin and viewing one of the inner panels. Alternately, an answer or a “hint” can also be viewed by moistening the front panel of the napkin where the question appears so that the answer or “hint” printed on one of the inner panels shows through.

### BRIEF DESCRIPTION OF THE DRAWINGS

FIG. 1 is a front perspective view of one of multiple paper napkins comprising a thematic set of paper napkins in accordance with the preferred embodiment of the present invention.

FIG. 2 is a plan view of the paper napkin of FIG. 1 unfolded, showing the obverse side.

FIG. 3 is a plan view of the paper napkin of FIG. 1 unfolded, showing the reverse side.

### DETAILED DESCRIPTION OF THE PREFERRED EMBODIMENT

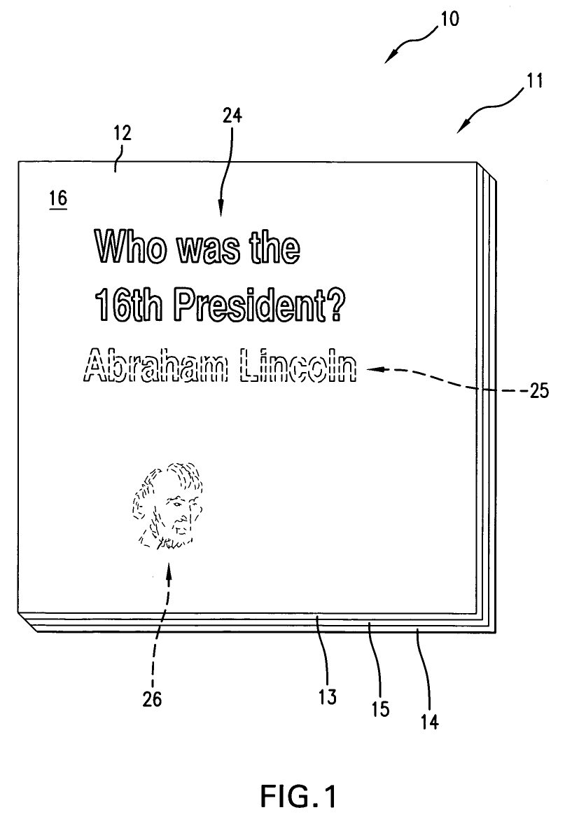

For illustrative purposes, the detailed description of the preferred embodiment of the present invention 10 will refer to a set of paper napkins to be used for elementary-school-level educational instruction. Such napkins could be distributed to students in the elementary school for use at snack and/or lunch breaks, or they could be used in the home by parents as a way of supplementing or reinforcing their children's school work. For illustrative purposes, the theme of the napkin set described in detail herein is the Presidents of the United States of America. FIGS. 1-3 depict an exemplary paper napkin 11 from this Presidential theme set. As shown in FIG. 1, imprinted on the exemplary napkin 11 is the question: “Who was the 16^{th} President?”

While the exemplary paper napkin 11 has a typical quadrifold structure, the present invention 10 can be practiced using a variety of other paper napkin folding patterns. As depicted in FIG. 1, the exemplary quadrifold paper napkin 11 opens from right to left, like a book. While this orientation is used for illustrative purposes, the present invention 10 can be practiced with a quadrifold paper napkin in any of its four possible orientations.

The exemplary quadrifold paper napkin 11 comprises four plies: a front outer ply 12, a front inner ply 13, a back outer ply 14, and a back inner ply 15. In the folded configuration of the napkin 11, as shown in FIG. 1, these four plies are superimposed one over the other in following order: front outer ply 12 over front inner ply 13 over back inner ply 15 over back outer ply 14.

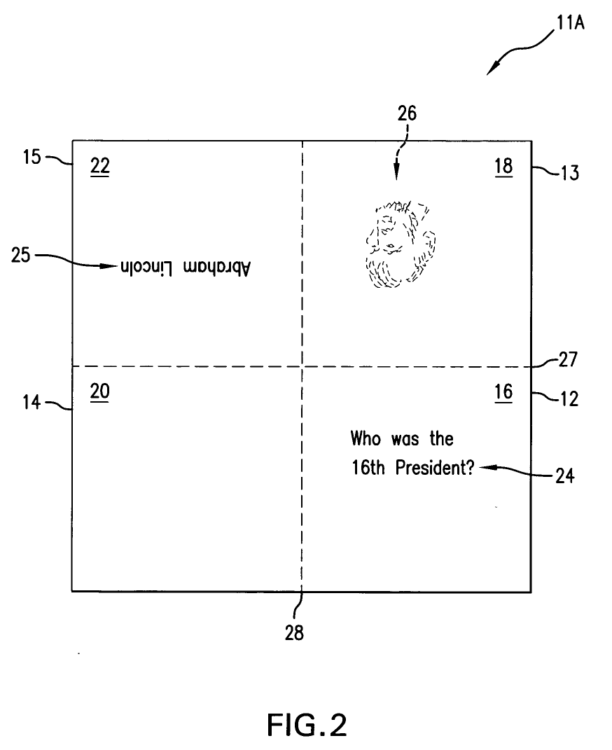

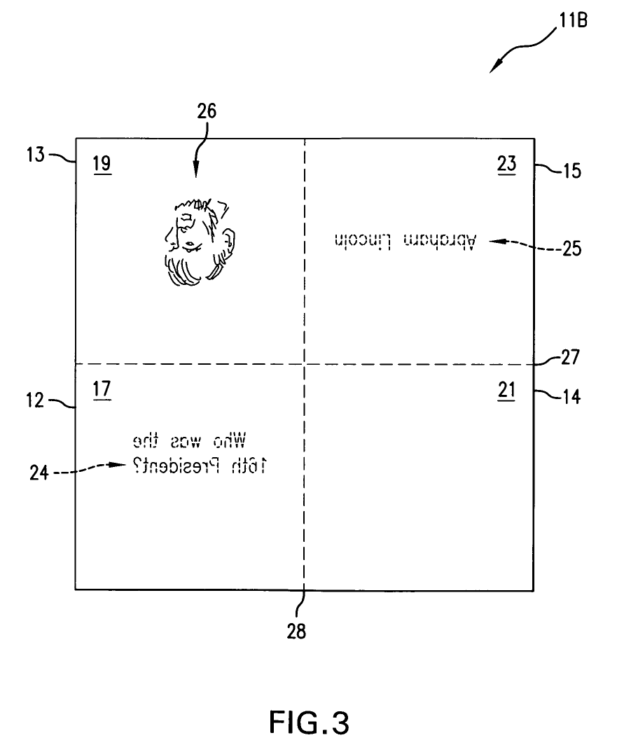

When unfolded, as shown in FIGS. 2 and 3, the napkin 11 has two sides: an obverse side 11A, as depicted in FIG. 2, and a reverse side 11B, as depicted in FIG. 3. Each side is divided into four quadrants by a first fold 27 and a second fold 28. On the obverse side 11A, the four quadrants comprise: a front outer ply obverse 16, a front inner ply obverse 18, a back outer ply obverse 20, and a back inner ply obverse 22. On the reverse side 11B, the four quadrants comprise: a front outer ply reverse 17, a front inner ply reverse 19, a back outer ply reverse 21, and a back inner ply 23.

As shown in FIG. 2, a question text 24 is imprinted on the front outer ply obverse 16. Optionally, an answer text 25 (in this example “Abraham Lincoln”) can be imprinted, inverted with respect to the question text 24, on the back inner ply obverse. In this way, the answer 25 to the question 24 can be viewed by unfolding the second fold 28 of the napkin from right to left, in book fashion. As depicted in FIG. 3, another option is to imprint a text and/or image “hint” 26 (in this example, a small portrait of Lincoln), also inverted with respect to the question text 24, on the front inner ply reverse 19. In this way, the hint 26 can be viewed, without unfolding the napkin 11 to reveal the answer 25, by moistening the bottom of the front outer ply obverse 16, thereby rendering that part of the front outer ply 12 translucent and making visible the hint 26 imprinted on the underlying front inner ply 13.

Although a preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A set of paper napkins, comprising multiple individual paper napkins, wherein each individual paper napkin has one or more imprinted question(s), such that the imprinted question(s) on each individual paper napkin are different from the imprinted questions on all of the other individual paper napkins comprising the set, and such that all of the imprinted questions on all of the individual paper napkins comprising the set relate to a specific subject, theme, age group, interest and/or social setting.

2. The set of paper napkins according to claim 1, wherein the individual paper napkins have multiple plies that are folded, one over the other, and wherein the imprinted question(s) appear on one or more of the plies.

3. The set of paper napkins according to claim 2, wherein one or more of the plies are outer plies that are exposed when the individual paper napkins are folded, and wherein the imprinted question(s) appear on one or more of the outer plies.

4. The set of paper napkins according to claim 3, wherein one or more of the plies are inner plies that are not exposed when the individual paper napkins are folded, and wherein one or more imprinted answer(s) to the imprinted question(s) appear on one or more of the inner plies, such that the imprinted answer(s) become visible when the individual paper napkins are unfolded.

5. The set of paper napkins according to claim 4, wherein one or more imprinted hints(s) regarding the imprinted answer(s) to the imprinted question(s) appear on one or more of the inner plies, such that the imprinted hint(s) become visible when the individual paper napkins are unfolded or when one or more of the outer ply/plies is/are moistened.
